(19) United States
(12) Patent Application Publication
(10) Pub. No.: US 2013/0251896 A1
(43) Pub. Date: Sep. 26, 2013

(54) METHOD OF PROTECTING COMPONENT OF FILM FORMING APPARATUS AND FILM FORMING METHOD

(71) Applicant: TOKYO ELECTRON LIMITED, Tokyo (JP)

(72) Inventors: Yamato TONEGAWA, Nirasaki City (JP); Hidenobu SATO, Nirasaki City (JP); Koji SASAKI, Nirasaki City (JP); Nobuhiro TAKAHASHI, Nirasaki City (JP); Keisuke SUZUKI, Nirasaki City (JP)

(73) Assignee: TOKYO ELECTRON LIMITED, Tokyo (JP)

(21) Appl. No.: 13/845,692

(22) Filed: Mar. 18, 2013

(30) Foreign Application Priority Data
Mar. 23, 2012 (JP) 2012-067573

(51) Int. Cl. B05D 5/00

(52) U.S. Cl. CPC B05D 5/00
USPC 427/154

(57) ABSTRACT

Provided is a method of protecting a component of a film forming apparatus, which includes forming a film having a rough surface on a surface of a component which is provided in the interior of the processing chamber of a film forming apparatus such that the surface of the component is coated with the film having the rough surface, the component being exposed to a film forming atmosphere during a film forming process. Forming a film having a rough surface on a surface of the component is in some embodiments performed before or after the film forming process is performed on target substrate and in some cases both before and after.

### CROSS-REFERENCE TO RELATED APPLICATION

This application claims the benefit of Japanese Patent Application No. 2012-067573 filed on Mar. 23, 2012, in the Japan Patent Office, the disclosure of which is incorporated herein in its entirety by reference.

### TECHNICAL FIELD

The present disclosure relates to a method of protecting components of a film forming apparatus and a film forming method.

### BACKGROUND

In manufacturing semiconductor integrated circuit devices, a film forming apparatus is used for forming a thin film. The film forming apparatus deposits, for example, silicon, silicon oxide, silicon nitride or the like on a semiconductor wafer that is a target substrate to be processed, and forms a silicon film, a silicon oxide film, a silicon nitride film or the like on the semiconductor wafer.

However, such a deposition does not occur only on the semiconductor wafer, but on an inner surface of a processing chamber or surfaces of components arranged within the processing chamber such as a processing gas inlet tube and the like. For this reason, after performing the film forming processing several times, a so-called cleaning process has to be performed to remove the thin films deposited on the inner surface of the processing chamber or the components such as the processing gas inlet tube and the like.

As described above, the thin films deposited on the components are cleaned and removed after the film forming process is performed several times.

However, the thin film subjects the components to a strong stress. For example, in case of components made of quartz, the component is subjected to a strong tensile stress when silicon nitride is deposited on the component. If the deposition of silicon nitride accumulates, the component is more likely have fine cracks, and finally, a superficial layer portion of the component could be thinly delaminated and then fall off.

As described above, a component which is finely cracked or has a portion that has a superficial layer of damage which could be thinly delaminated may be a source of unwanted particles.

### SUMMARY

The present disclosure provides a component protection method of a film forming apparatus capable of suppressing damage of a component of the film forming apparatus even though a thin film has been deposited on the component, and a film forming method including the component protection method.

According to a first aspect of the present disclosure, provided is a component protection method of protecting a component of a film forming apparatus, the method comprising forming a film having a rough surface on a surface of a component of a film forming apparatus such that the surface of the component is coated with the film having the rough surface, before or after film forming processing on a target substrate in the interior of a processing chamber of a film forming apparatus, and the component being located in the interior of the processing chamber and exposed to a film forming atmosphere during the film forming processing on the target substrate.

According to a second aspect of the present disclosure, provided is a film forming method of performing film forming processing on a target substrate, the method comprising carrying the target substrate into an interior of a processing chamber of a film forming apparatus, the target substrate being loaded in a substrate loading jig; performing film forming processing on the target substrate in the interior of the processing chamber; and forming a film having a rough surface on a surface of a component of a film forming apparatus such that the surface of the component is coated with the film having the rough surface, before film forming processing on a Target substrate, or after the film forming processing on the target substrate, or both before and after the film forming processing on the target substrate, and the component being located in the interior of the processing chamber and exposed to a film forming atmosphere during the film forming processing on the target substrate.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a longitudinal sectional view showing an example of a film forming apparatus to which a component protection method according to an embodiment of the present disclosure may be applied;

FIG. 2 is a transverse sectional view of the film forming apparatus shown in FIG. 1;

FIG. 3 is a flow chart illustrating an example of a component protection method according to a first embodiment of the present disclosure;

FIGS. 4A to 4C are enlarged sectional views schematically showing a portion of a component;

FIG. 5 is a flow chart illustrating an example of a component protection method according to a second embodiment of the present disclosure;

FIGS. 6A to 6C are enlarged sectional views schematically showing a portion of a component;

FIG. 7 is a view illustrating stress on a silicon nitride film;

FIG. 8 is a flow chart illustrating an example of a component protection method according to a third embodiment of the present disclosure; and

FIG. 9 is a flow chart illustrating an example of a component protection method according to a fourth embodiment of the present disclosure.

### DETAILED DESCRIPTION

Hereinafter, embodiments of the present disclosure will be described with reference to the drawings. In addition, throughout the drawings, like reference numerals are used to designate like elements.

### <Film Forming Apparatus>

First of all, an example of a film forming apparatus, to which a component protection method according to an embodiment of the present disclosure may be applied, will be described.

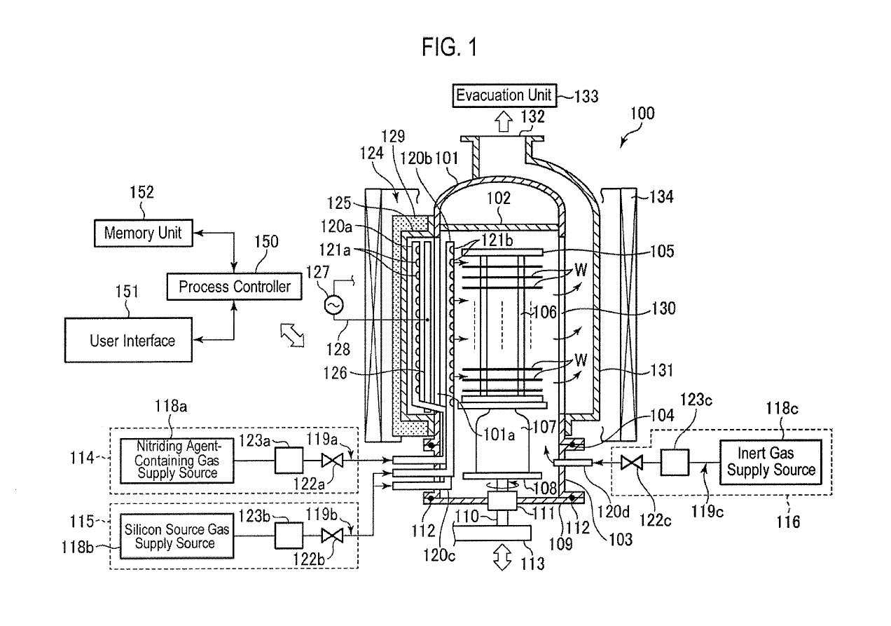

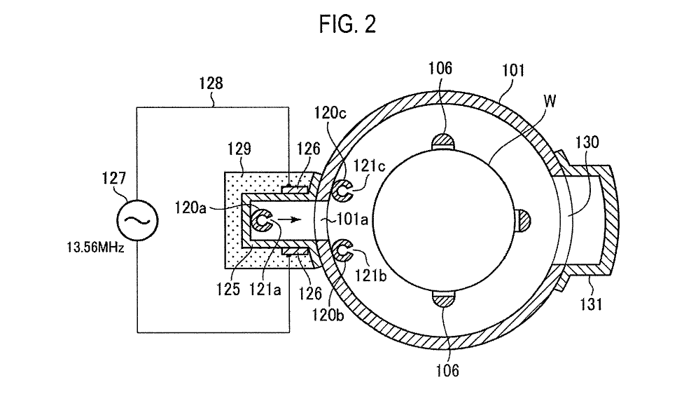

FIG. 1 is a longitudinal sectional view showing an example of a film forming apparatus to which a component protection method according to an embodiment of the present disclosure may be applied; and FIG. 2 is a transverse sectional view of the film forming apparatus shown in FIG. 1.

FIG. 1 shows a batch type film forming apparatus 100 for forming a silicon nitride film on a semiconductor wafer (silicon substrate) W, which is a target substrate to be processed, using an ALD (Atomic Layered Deposition) method, as an example of a film forming apparatus to which a component protection method according to an embodiment of the present disclosure may be applied.

As shown in FIG. 1, the film forming apparatus 100 includes a cylindrical processing chamber 101 having an open lower end and a ceiling. The processing chamber 101 is entirely formed, for example, of quartz. A quartz ceiling plate 102 is located at the ceiling of the processing chamber 101 and makes acts as a seal. In addition, a manifold 103, which, for example, is formed of stainless steel in the shape of a cylinder, is connected to the opening of the lower end of the processing chamber 101 through a sealing member 104 such as an O-ring.

The manifold 103 supports the lower end of the processing chamber 101. A wafer boat 105 made of quartz, to which plural sheets, for example, 50 to 100 sheets of semiconductor wafers W can be loaded in a multistage manner, can be carried into or out of the processing chamber 101 from the bottom of the manifold 103. The wafer boat 105, which is a substrate loading jig configured to load a target substrate to be processed, has, for example, three pillars 106 (see FIG. 2), and allows plural sheets of wafers W to be supported by means of grooves (not shown) formed in the pillars 106.

The wafer boat 105 is loaded on a table 108 through a thermal insulation container 107 made of quartz. The table 108 is supported on a rotating shaft 110, which penetrates a lid portion 109 opening and closing a lower end of the manifold 103, for example, the lid portion 109 is made of stainless steel.

In addition, the portion penetrated by the rotating shaft 110, for example, is fitted with a magnetic fluid seal 111 and airtightly seals and supports the rotating shaft 110 to be rotatable. Also, a sealing member 112 such as an O-ring is interposed and installed between a periphery of the lid portion 109 and the lower end of the manifold 103, thereby maintaining the processing chamber 101 to be sealed.

The rotating shaft 110 is mounted to a leading end of an arm 113 supported by a lift unit (not shown) such as a boat elevator and is configured to lift up or down the wafer boat 105, the lid portion 109, and the like together so that they can be inserted into or be separated from the processing chamber 101. In addition, the table 108 may be fixedly installed to the lid portion 109, and thus, the wafers W may be processed without rotating the wafer boat 105.

The film forming apparatus 100 is provided with a nitriding agent-containing gas supply unit 114, a silicon source gas supply unit 115, and an inert gas supply unit 116. The nitriding agent-containing gas supply unit 114 feeds a nitriding agent-containing gas into the processing chamber 101. The silicon source gas supply unit 115 also feeds a silicon source gas into the processing chamber 101. The inert gas supply unit 116 also feeds an inert gas into the processing chamber 101. The inert gas is used, for example, as a purge gas and a dilution gas within the processing chamber 101.

The nitriding agent-containing gas may include, for example, ammonia (NH₃)-containing gas, nitrogen oxide (NO)-containing gas, ammonia and nitrogen oxide-containing gas, and the like. The silicon source gas may include, for example, silane-based gas, such as monosilane (SiH₄), disilane (Si₂H₆), or dichlorosilane (DCS:SiH₂Cl₂).

In addition, a plurality of silicon source gases are prepared in the silicon source gas supply unit 115, and at least one of the prepared silicon source gases may be selected to be fed into the processing chamber 101. The inert gas includes, for example, nitrogen gas (N₂ gas), argon gas (Ar gas), and the like.

The nitriding agent-containing gas supply unit 114 is configure to includes a nitriding agent-containing gas supply source 118a, a nitriding agent-containing gas supply line 119a for inducing a nitriding agent-containing gas from the nitriding agent-containing gas supply source 118a, an opening and closing valve 122a and a flow controller 123a which are installed in the middle of the nitriding agent-containing gas supply line 119a.

The silicon source gas supply unit 115 is configured to include a silicon source gas supply source 118b, a silicon source gas supply line 119b for inducing a silicon source gas from the silicon source gas supply source 118b, an opening and closing valve 122b and a flow controller 123b which are installed in the middle of the silicon source gas supply line 119b.

The inert gas supply unit 116 is configured to include an inert gas supply source 118c, an inert gas supply line 119c for inducing an inert gas from the inert gas supply source 118c, an opening and closing valve 122c and a flow controller 123c which are installed in the middle of the inert gas supply line 119c.

The gas inlet tubes such as a nitriding agent-containing gas dispersion nozzle 120a, silicon source gas dispersion nozzles 120b and 120c, and an inert gas inlet nozzle 120d are arranged in the processing chamber 101 and supply the processing gas into the processing chamber 101. The nitriding agent-containing gas supply line 119a is connected to a nitriding agent-containing gas dispersion nozzle 120a, which consists of a quartz tube penetrating a sidewall of the manifold 103 inwards, bent upwards and extending vertically. The silicon source gas supply line 119b is also connected to silicon source gas dispersion nozzles 120b and 120c, each of which consists of a quartz tube penetrating the sidewall of the manifold 103 inwards, bent upwards and extending vertically. Each of the nitriding agent-containing gas dispersion nozzle 120a and the silicon source gas dispersion nozzles 120b and 120c has a plurality of gas injection holes 121a to 121c formed in the vertical portion thereof to be spaced apart from each other at a predetermined interval (see FIG. 2 for the gas injection holes 121c). In addition, the inert gas supply line 119c is connected to an inert gas inlet nozzle 120d, which penetrates the sidewall of the manifold 103 inwards.

The aforementioned configuration allows the nitriding agent-containing gas, the silicon source gas and the inert gas to be independently supplied into the processing chamber 101 while the flow rate of each gas is independently controlled.

A plasma generation unit 124 for generating plasma of the nitriding agent-containing gas is formed on a portion of a sidewall of the processing chamber 101. The plasma generation unit 124 has a plasma compartment wall 125. The plasma compartment wall 125 is airtightly connected to an outer wall of the processing chamber 101 in order to cover an opening 101a formed in the sidewall of the processing chamber 101. The opening 101a is formed to be vertically elongated by cutting the sidewall of the processing chamber 101 off in the vertical direction to have a predetermined width. This is to uniformly supply plasmas and radicals through the opening 101a to all of the wafers W held and supported on the wafer boat 105 in a multistage manner. Further, the plasma compartment wall 125 is formed to have a U-shaped cross section and to be vertically elongated corresponding to the shape of the opening 101a and, for example, is made of quartz. The plasma compartment wall 125 is formed on the processing chamber 101, so that the portion of the sidewall of the processing chamber 101 protrudes outward to be convex and an inner space of the plasma compartment wall 125 is in integral communication with an inner space of the processing chamber 101.

The plasma generation unit 124 is provided with a pair of plasma electrodes 126 (see FIG. 2), a high frequency power supply 127, and a feed line 128 for feeding high frequency power from the high frequency power supply 127. The pair of plasma electrodes 126, each of which is formed to be long and narrow to conform to the shape of the plasma compartment wall 125, are arranged to face each other on outer surfaces of both sidewalls of the plasma compartment wall 125 along the vertical direction.

While extending upward within the processing chamber 101, the nitriding agent-containing gas dispersion nozzle 120a is bent toward the outside of the processing chamber 101 and then erected upward along the innermost portion (the furthermost portion from the center of the processing chamber 101) within the plasma compartment wall 125. Thus, if the high frequency power supply 127 is turned on to generate a high frequency electric field between the pair of plasma electrodes 126, the nitriding agent-containing gas injected from the gas injection holes 121 a of the nitriding agent-containing gas dispersion nozzle 120a is plasma-excited, radicals of the nitriding agent-containing gas are generated, and then, they diffuse and flow toward the center of the processing chamber 101. For example, if a high frequency voltage of 13.56 MHz is applied from the high frequency power supply 127 to the pair of plasma electrodes 126, the nitriding agent-containing gas supplied to the space defined by the plasma compartment wall 125 is plasma-excited, and radicals of the nitriding agent-containing gas are generated. For example, if the nitriding agent-containing gas is ammonia, ammonia radicals are generated, and the ammonia radicals react with a silicon source gas or a silicon film in the processing chamber 101, so that a silicon nitride film can be formed. Also, the frequency of the high frequency voltage is not limited to 13.56 MHz, but the other frequencies, e.g., 400 kHz and the like, may be used.

In order to cover the plasma compartment wall 125, an insulation protection cover 129, which, for example, is made of quartz, is mounted to the outside of the plasma compartment wall 125.

An evacuation opening 130 for vacuum evacuating the processing chamber 101 is installed to an opposite portion of the opening 101a of the processing chamber 101. The evacuation opening 130 is formed to be narrow and long by cutting off the sidewall of the processing chamber 101 in the vertical direction. An evacuation opening cover member 131, which is formed to have a U-shaped cross section in order to cover the evacuation opening 130, is mounted to a portion corresponding to the evacuation opening 130 of the processing chamber 101 by welding. The evacuation opening cover member 131 extends upward along the sidewall of the processing chamber 101 and defines a gas outlet 132 at an upper portion of the processing chamber 101. An evacuation unit 133, including a vacuum pump or the like, is connected to the gas outlet 132. The evacuation unit 133 evacuates the processing chamber 101 to exhaust the processing gas used in the processing and to make the pressure in the processing chamber 101 be a processing pressure required as the processing progresses.

A cylindrical heating unit 134 is installed on an outer periphery of the processing chamber 101. The heating unit 134 activates the gas supplied into the processing chamber 101 and simultaneously heats the wafers W accommodated in the processing chamber 101. Meanwhile, the heating unit 134 is omitted from being shown in FIG. 2.

The control of each component of the film forming apparatus 100 is performed, for example, by a process controller 150 consisting of a microprocessor (computer). A user interface 151, which includes a keyboard or touch panel for input operation of commands and the like for an operator to control the film forming apparatus 100, a display for visualizing and displaying the operational status of the film forming apparatus 100, and the like, is connected to the process controller 150.

A memory unit 152 is connected to the process controller 150. The memory unit 152 stores a control program for implementing various kinds of processing performed in the film forming apparatus 100 by controlling the process controller 150, or stores a program for performing the processing for the respective components of the film forming apparatus 100 according to processing conditions, i.e., a recipe. The recipe is stored, for example, in a storage medium of the memory unit 152. The storage medium may be a portable memory, such as a CD-ROM, DVD, or flash memory, as well as a hard disk or semiconductor memory. In addition, the recipe may be suitably transmitted from other units, for example, through a dedicated line. The recipe, if necessary, is read from the memory unit 152 by instructions or the like from the user interface 151 and the processing according to the read recipe is performed by the process controller 150, so that the processing for forming a silicon nitride film is performed in the film forming apparatus 100 under the control of the process controller 150.

In embodiments of the present disclosure, component protective coatings are formed on components provided in the film forming apparatus 100. Hereinafter, some embodiments will be described in detail.

### First Embodiment

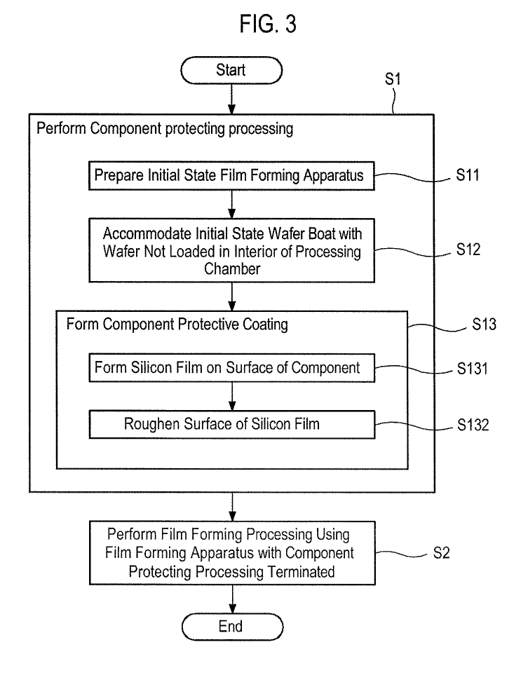

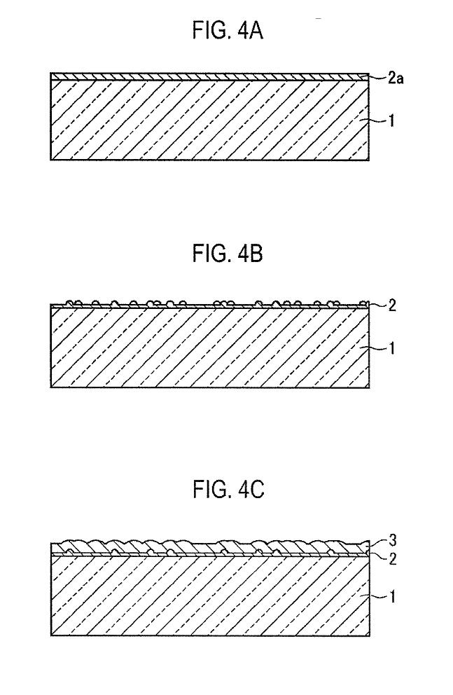

FIG. 3 is a flow chart illustrating an example of a component protection method according to a first embodiment of the present disclosure; and FIGS. 4A to 4C are enlarged sectional views schematically showing a portion of a component.

The first embodiment is an example of forming a component protective coating on a surface of a quartz component which is exposed to a film forming atmosphere during the film forming processing, before a silicon nitride film is formed.

As shown in operation S1 of FIG. 3, the component protecting processing is performed. In this embodiment, the component protecting processing is performed as follows.

First of all, the film forming apparatus 100 in an initial state is prepared (operation S11). Herein, the term “initial state” is a state that film forming processing is not performed directly after the film forming apparatus 100 has finished or a state that film forming processing is not performed directly after the film forming apparatus 100 has cleaned. Then, the wafer boat 105 in an initial state where the wafers W are not loaded is accommodated in the interior of the processing chamber 101 of the film forming apparatus 100 in the initial state (operation S12).

Next, the silicon source gas supply unit 115 included in the film forming apparatus 100 is used to form component protective coatings on the surfaces of the quartz components arranged in the interior of the processing chamber 101 (operation S13). In this embodiment, the component protective coating includes a rough surface film having an undulated surface and is made of silicon. Namely, in this embodiment, a silicon film having a rough surface is formed as the component protective coating. Also, the reason why the silicon is selected as the material of the component protective coating is as follows.

If a film formed by means of the film forming apparatus 100 is a silicon nitride film, a silicon nitride film is also formed on the surface of the quartz component arranged in the interior of the processing chamber 101. This silicon nitride film causes the component to be subjected to a strong tensile stress. The silicon film formed on the component as the component protective coating applies a compressive stress to the silicon nitride film and serves to relieve the tensile stress caused by the silicon nitride film. As such, in this embodiment, the silicon film having a stress for canceling the stress generated in the silicon nitride film formed on the quartz component is used as the component protective coating. This is one reason for selecting the silicon film as the component protective coating. Further, the component protective coating can be roughened to relieve the tensile stress caused by the silicon nitride film.

In this embodiment, a silicon film having a rough surface is formed as follows.

First, a silicon film 2 is formed on the surface of the component (operation S131). An example of a film forming condition when the silicon film 2 is formed is as follows:
Silicon Source Gas: Monosilane,
Flow Rate of Silicon Source Gas: 300 to 500 sccm,
Processing Time: 3 min,
Processing Temperature: 500 to 600 degrees C., and
Processing Pressure: 13.3 to 26.6 Pa (0.1 to 0.2 Torr).

According to this film forming processing, a silicon film 2a is formed on a surface of a quartz component 1 arranged in the processing chamber 101 (see FIG. 4A). In this embodiment, the surface of the quartz component 1 includes an inner wall surface of the processing chamber 101, an inner wall surface of the ceiling plate 102, an outer peripheral surface of the wafer boat 105 including the pillars 106, an outer peripheral surface of thermal insulation container 107, an outer peripheral surface of the nitriding agent-containing gas dispersion nozzle 120a, outer peripheral surfaces of the silicon source gas dispersion nozzles 120b and 120c, an outer peripheral surface of the inert gas inlet nozzle 120d, and an inner wall surface of the plasma compartment wall 125.

Next, a surface of the silicon film 2a is roughened (operation S132). An example of a surface roughening condition when roughening the surface of the silicon film 2a is as follows:
Processing Time: 30 min,
Processing Temperature: 550 to 600 degrees C., and
Processing Pressure: Vacuum.

The term “vacuum” in the aforementioned condition means that the evacuation unit 133 is used to continuously evacuate the processing chamber 101 and maintain the internal pressure of the processing chamber 101 at a high degree of vacuum. For example, the internal pressure of the processing chamber 101 is lower than that of forming the silicon film 2a.

The surface roughening processing causes silicon to be agglomerated on the surface of the silicon film 2a and the surface of the silicon film 2a to be roughened. Accordingly, the silicon film 2 having the rough surface is completed as the component protective coating (see FIG. 4B). In this embodiment, each of the inner wall surface of the processing chamber 101, the inner wall surface of the ceiling plate 102, the outer peripheral surface of the wafer boat 105 including the pillars 106, the outer peripheral surface of thermal insulation container 107, the outer peripheral surface of the nitriding agent-containing gas dispersion nozzle 120a, the outer peripheral surfaces of the silicon source gas dispersion nozzles 120b and 120c, the outer peripheral surface of the inert gas inlet nozzle 120d, and the inner wall surface of the plasma compartment wall 125 is coated with the silicon film 2 having the rough surface. Accordingly, the component protecting processing is finished.

Thereafter, the film forming apparatus 100 in which the component protecting processing is finished is used to perform the film forming processing (operation S2). To this end, first, the wafer boat 105 having the outer peripheral surface coated with the silicon film 2 having the rough surface is withdrawn from the interior of the processing chamber 101, and the wafer boat 105 is loaded with the semiconductor wafers W to be formed with films. Then, the wafer boat 105 with the semiconductor wafers W loaded therein is accommodated in the processing chamber 101 again, and the semiconductor wafers W are carried into the processing chamber 101.

Next, a film, e.g., a silicon nitride film in this embodiment, is formed. The silicon nitride film is formed by a well-known film forming method, such as a CVD (Chemical Vaporization Deposition) method or an ALD method. In this embodiment, the silicon nitride film is formed by an ALD method using dichlorosilane (DCS:SiH₂Cl₂) gas as the silicon source gas and ammonia (NH₃) gas as the nitriding agent-containing gas. For example, first, dichlorosilane gas is fed into the interior of the processing chamber 101, which is heated by the heating unit 134. Accordingly, a thin silicon film at an atomic layer level is formed on a surface of the semiconductor wafer W to be processed. Then, the interior of the processing chamber 101 is purged using inert gas. Then, ammonia gas is plasma-excited to generate ammonia radicals, and the ammonia radicals react with the silicon film. Accordingly, the silicon film is nitrided to form a silicon nitride film. Then, the interior of the processing chamber 101 is purged using inert gas. Such a film forming cycle is repeated a plurality of times so that a silicon nitride film 3 having a designed film thickness is formed on the surface of the semiconductor wafer W to be processed.

In addition, when this film forming processing is performed, silicon nitride is deposited evenly on the components, which are arranged within the processing chamber 101 and coated with the silicon film 2 having the rough surface, and the silicon nitride film 3 is formed thereon (see FIG. 4C).

Next, the wafer boat 105 is carrying out of the interior of the processing chamber 101, whereby the semiconductor wafers W are taken out of the interior of the processing chamber 101.

Hereby, the film forming processing of the silicon nitride film using the film forming apparatus 100, to which the component protection method according to the first embodiment of the present disclosure is applied, are terminated.

According to the component protection method of this first embodiment, the surface of the quartz component is coated with the silicon film 2 having a rough surface, which is the component protective coating, before the silicon nitride film is deposited. For this reason, it is possible to suppress the generation of cracks and delamination of a superficial layer portion of the quartz component caused by the deposition of the silicon nitride film.

In addition, against the silicon nitride film having a tensile stress, silicon having a compressive stress opposite thereto is used as a material of the component protective coating. For this reason, even though the silicon nitride film is deposited on the surface of the component, it is possible to relieve the stress having the silicon nitride film as described above.

Further, according to the first embodiment, the silicon film 2 having the rough surface having a largely undulated surface is used as the component protective coating. For this reason, the stress having the silicon nitride film can be dispersed to be more relieved. Therefore, according to first embodiment, in which the film having the rough surface, for example, the silicon film having the rough surface is used as the component protective coating, it is possible to obtain an advantage of improving an effect of relieving stress as compared with a case where a silicon film having a flat surface is used as the component protective coating.

Considering the surface flatness of the film to disperse and relive the stress, an average surface roughness of the silicon film 2 having the rough surface may approximately range from 3.1 to 5 nm and an average film thickness of the silicon film 2 having the rough surface may approximately range from 10 to 30 nm, in some embodiments. To this end, the silicon film 2a may be approximately formed to have a film thickness of 5 to 10 nm, before the surface of the silicon film 2a is roughened.

Further, as a kind of a film having a finely uneven surface, there is a polycrystalline film such as a polycrystalline silicon film. For this reason, a polycrystalline silicon film can be used as the component protective coating. However, a general surface flatness of the polycrystalline silicon film is represented by an average surface roughness of 2 to 3 nm or so. For this reason, in order to further relieve the stress, it is advantageous in some embodiments to use the silicon film 2 having the rough surface. For example, if the average surface roughness of the component protective coating exceeds the above average surface roughness of the polycrystalline silicon film, an effect of relieving stress is further improved as compared with a case where the polycrystalline silicon film is used as the component protective coating.

Furthermore, in order to further increase the undulation of the surface of the silicon film 2 having the rough surface, the silicon film 2a formed prior to the surface roughening processing is formed to include an amorphous state. If the silicon film 2a includes an amorphous state, surface fluidity is improved, for example, as compared with a polycrystalline state in which crystallization proceeds. For this reason, in the surface roughening processing, agglomeration of silicon is promoted, so that it is possible to further increase the undulation of the surface of the silicon film 2 having the rough surface. If the undulation of the surface of the silicon film 2 having the rough surface can be increased, it is possible to further increase an effect of dispersing the stress of the silicon nitride film 3 deposited on the silicon film 2 having the rough surface. Also, the silicon film 2a formed under the aforementioned processing condition is formed in a state where an amorphous silicon film is included.

Furthermore, a method of roughening the surface of the silicon film 2a also includes a method of striking the surface of the silicon film 2a by sputtering, sand blast or the like to form unevenness on the surface. However, a sputtering unit or sand blast unit does not exist in the interior of the processing chamber 101 of the film forming apparatus 100. In addition, it is also impractical to install the sputtering unit or sand blast unit in the interior of the processing chamber 101.

In that sense, according to a method in which after the silicon film 2a is formed on the surface of the component, silicon of a surface portion of the silicon film 2a is agglomerated by dropping the pressure of the interior of the processing chamber 101 and unevenness is formed on the surface of the silicon film 2a, it is not necessary to install the sputtering unit or sand blast unit to the interior of the processing chamber 101. Also, only using the silicon source gas supply unit 115, the evacuation unit 133, the heating unit 134 and the like originally provided in the film forming apparatus 100, it is possible to form the silicon film 2 having the rough surface on the surfaces of the components arranged in the processing chamber 101. Of course, if the silicon film 2 having the rough surface, or a thin film formed on the silicon film 2 having the rough surface, e.g., the silicon nitride film 3 in this embodiment, together with the silicon film 2 having the rough surface, is etched by using a dry cleaning method, it is also possible to initialize the components.

According to this first embodiment, the surface of the component is directly coated with the component protective coating having an undulated surface, whereby it is possible to obtain the component protection method of a film forming apparatus capable of suppressing damage of the component of the film forming apparatus 100 even though the deposition of a thin film on the component proceeds. In addition, by including the component protection method, it is possible to form a thin film while particles are prevented from being generated in the interior of the processing chamber 101.

### Second Embodiment

The first embodiment is an example of forming the component protective coating on the surface of the component of the film forming apparatus 100 in an initial state before a silicon nitride film is formed. However, the component protective coating may also be formed after the silicon nitride film is formed. A second embodiment is such an example.

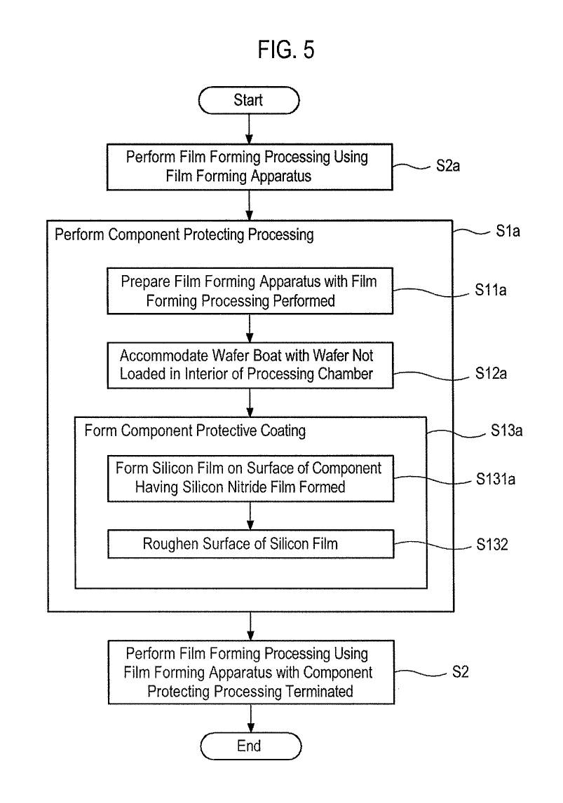

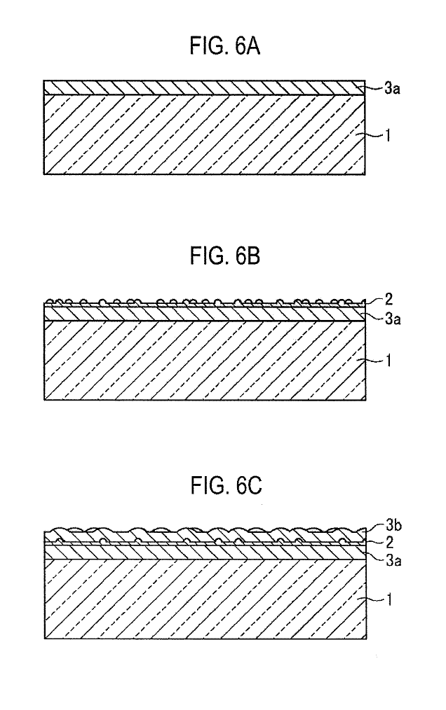

FIG. 5 is a flow chart illustrating an example of a component protection method according to the second embodiment of the present disclosure; and FIGS. 6A to 6C are enlarged sectional views schematically showing a portion of a component.

First, a silicon nitride film is formed using the film forming apparatus 100 (operation S2a). The film forming apparatus 100 may be either in an initial state or a state where, for example, a silicon nitride film has been formed several times (about one to five times). In this embodiment, the film forming apparatus 100 in an initial state is used. In order to form a silicon nitride film, semiconductor wafers W on which the film forming processing will be performed are loaded in the wafer boat 105. Then, the wafer boat 105 having the semiconductor wafers W loaded therein is accommodated in the interior of the processing chamber 101.

Next, the film forming processing of a silicon nitride film is performed in the interior of the processing chamber 101, for example, using the processing condition as described in the first embodiment. Accordingly, a silicon nitride film 3a is formed on a surface of the quartz component 1 arranged in the interior of the processing chamber 101 (see FIG. 6A). In this embodiment, the surface of the quartz component 1 includes an inner wall surface of the processing chamber 101, an inner wall surface of the ceiling plate 102, an outer peripheral surface of the wafer boat 105 including the pillars 106, an outer peripheral surface of thermal insulation container 107, an outer peripheral surface of the nitriding agent-containing gas dispersion nozzle 120a, outer peripheral surfaces of the silicon source gas dispersion nozzles 120b and 120c, an outer peripheral surface of the inert gas inlet nozzle 120d, and an inner wall surface of the plasma compartment wall 125. The silicon nitride film 3a is formed on each surface of component 1.

Next, the wafer boat 105 is carried out of the interior of the processing chamber 101, and the semiconductor wafers W are taken out of the interior of the processing chamber 101. Accordingly, the film forming processing using the film forming apparatus 100 is terminated.

Thereafter, the component protecting processing is performed as shown in operation S1a of FIG. 5. First, the film forming apparatus 100 in which the film forming processing has been performed is prepared (operation S11a). Then, the wafer boat 105 with the wafers W not loaded therein is accommodated in the processing chamber 101 of the film forming apparatus 100 in which the film forming processing has been performed (operation S12a). The wafer boat 105 is what is used one time in the film forming processing in operation S2a.

Next, a component protective coating is formed on the surface of the quartz component 1 arranged in the interior of the processing chamber 101 (operation S13a). In this embodiment, the component protective coating is formed on the surface of the quartz component, which is has been arranged in the interior of the processing chamber 101 and has had the silicon nitride film 3a formed thereon. In this embodiment, the silicon film 2a is formed on the surface of the quartz component 1, which has had the silicon nitride film 3a formed thereon, under the same processing condition as the first embodiment (operation S131a). Then, the surface roughening processing is performed on the silicon film 2a under the same processing condition as the first embodiment (operation S132). Accordingly, the silicon film 2 having the rough surface, as the component protective coating, is formed on the silicon nitride film 3a (see FIG. 6B).

Thereafter, the film forming apparatus in which the component protecting processing is finished is used to perform the film forming processing (operation S2). The film forming condition may be the same, for example, as the condition in operation S2a. Using this film forming processing, a second silicon nitride film 3b is formed on the silicon film 2 having the rough surface (see FIG. 6C).

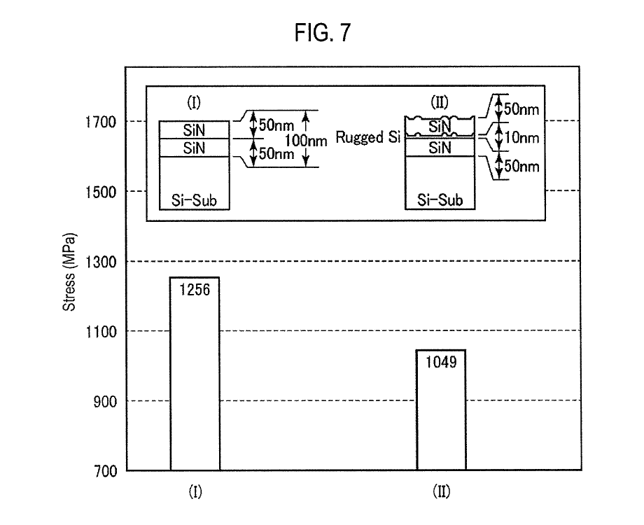

FIG. 7 is a view illustrating a stress of the silicon nitride film.

When a semiconductor wafer (Si-Sub) is the component, a stress of Sample I, in which a silicon nitride film (SiN) having a film thickness of 100 nm is fanned on the semiconductor wafer, and a stress of Sample II, in which there is formed a laminated film having a rough surface silicon film (Rugged Si) having an average film thickness of 10 nm formed between two silicon nitride films (SiN), each having a film thickness of 50 nm, are shown in FIG. 7. Sample I corresponds to a case where a film having a thickness of 50 nm is formed twice, and Sample II corresponds to this second embodiment.

As shown in FIG. 7, the stress of Sample I is 1256 MPa while the stress of Sample II is 1049 MPa, so that the stress of Sample II is relieved.

As such, the silicon film having the rough surface interposed between the two silicon nitride films can relieve the stress as compared with a case where the deposition of the silicon nitride film is accumulated.

Accordingly, also in the second embodiment, as the film having the rough surface is or becomes interposed between the thin films deposited on the surface of the component, it is possible to obtain the component protection method of a film forming apparatus capable of suppressing damage of the component of the film forming apparatus 100 even though the deposition of a thin film on the component proceeds, as in the first embodiment. In addition, by including the component protection method, the film forming method is possible to form a thin film while particles are prevented from being generated in the interior of the processing chamber 101.

### Third Embodiment

A third embodiment, which is an example of a combination of the first embodiment and the second embodiment, is an example of a component protection method which becomes more effective in practical use.

The film forming processing using the film forming apparatus 100 is repeated a plurality of times even after a component protective coating is formed. Whenever the film forming processing is performed, the deposition of a thin film, e.g., a silicon nitride film, is accumulated on a quartz component. Thus, the third embodiment is an example where a component protecting processing is further performed according to the number of thin film depositions, e.g., silicon nitride films.

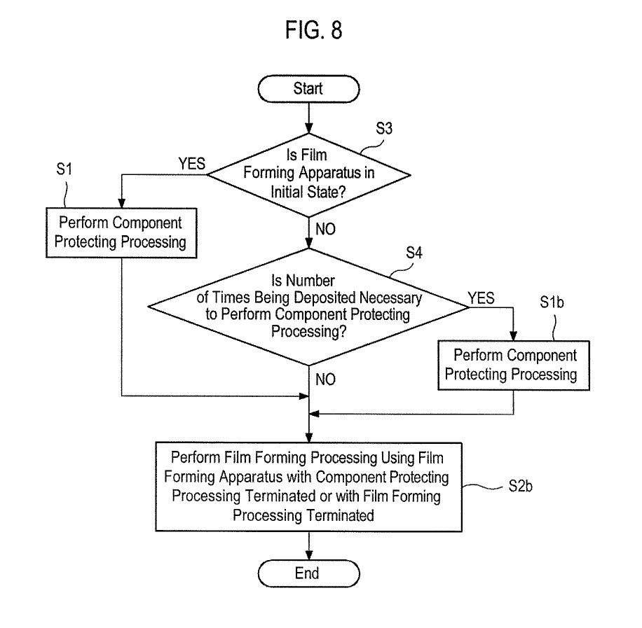

FIG. 8 is a flow chart illustrating an example of a component protection method according to the third embodiment of the present disclosure.

In operation S3 shown in FIG. 8, it is determined whether or not the film forming apparatus 100 is in an initial state. If it is in the initial state (YES), the process proceeds to operation S1 and the component protecting processing (operation S1 of FIG. 3) is performed, which has been described with reference to FIG. 3 and FIGS. 4A and 4B. Thereafter, the process proceeds to operation S2b, and the film forming processing using the film forming apparatus in which the component protecting processing is terminated, or the film forming processing using the film forming apparatus in which the film forming processing is terminated, e.g., the film forming processing of a silicon nitride film in this embodiment, is performed. In addition, a film forming condition in operation S2b may be the same, for example, as the film forming condition in operation S2 of the first embodiment and operation S2a of the second embodiment. On the Contrary, if it is not in the initial state (NO), the process proceeds to operation S4.

In operation S4, it is determined whether or not the number of depositions is the number necessary to perform the component protecting processing. If the component protecting processing is needed (YES), the process proceeds to operation S lb and the component protecting processing (operation S1a of FIG. 5) is performed, which has been described with reference to FIG. 5 and FIG. 6B. Thereafter, the process proceeds to operation S2b, and the silicon nitride film is formed as described above.

On the contrary, if the component protecting processing is not necessary (NO), the process proceeds to operation S2b and the silicon nitride film is formed in the same manner.

In order to perform the following film forming processing, a routine from “Start” to “End” shown in FIG. 8 has only to be repeated.

In this way, whenever the thin film, e.g., the silicon nitride film in this embodiment, is formed one or more times, the component protecting processing, which had been described in the first and second embodiments, may be performed.

According to this third embodiment, since the component protecting processing, which had been described in the first and second embodiments, is performed whenever the thin film is formed one or more times, it is advantageous to make it possible to suppress damage of the components of the film forming apparatus 100 while the film forming apparatus 100 operates in practice and the film forming processing is repeated. In addition, by including the component protection method, it is also possible to form a thin film while particles are prevented from being generated in the interior of the processing chamber 101.

Furthermore, as it is determined whether or not the film forming apparatus 100 is in an initial state prior to the film forming processing, the component protecting processing described in the first embodiment can be necessarily performed in the film forming apparatus 100 in the initial state.

### Fourth Embodiment

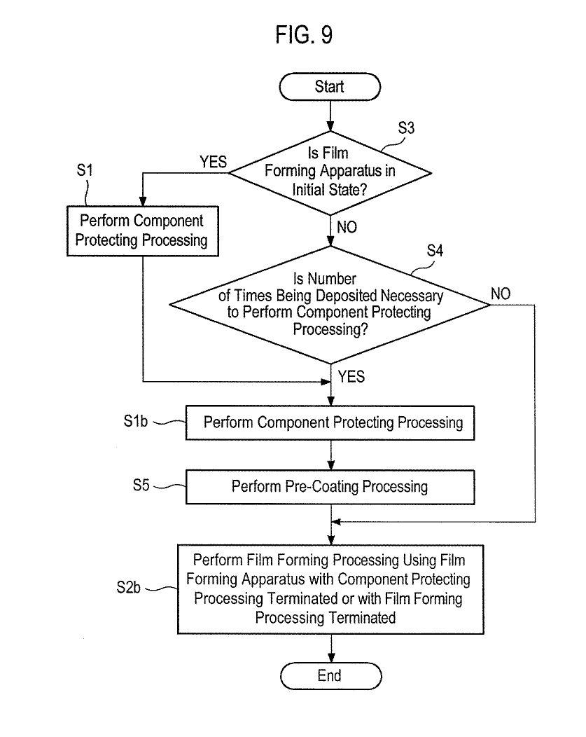

FIG. 9 is a flow chart illustrating an example of a component protection method according to a fourth embodiment of the present disclosure.

As shown in FIG. 9, the fourth embodiment is different from the third embodiment shown in FIG. 8 in that a pre-coating processing is performed as shown in operation S5 after the component protecting processing shown in operations S1a and S1b is performed. The others are the same as the third embodiment.

The silicon film 2 having the rough surface is formed as the component protective coating, and silicon nitride films 3 (3b) are formed as thin films to be formed. In this case, a material of the surface of the quartz component 1 arranged in the interior of the processing chamber 101 directly after the component protective coating 2 is formed becomes different from that directly after the film forming processing is performed. The material of the component protective coating 2 is silicon (Si) directly after the component protective coating 2 is formed, but the material of the component protective coating 2 is silicon nitride (SiN) directly after the film forming processing is performed. For this reason, there is a possibility for a film quality of the semiconductor wafers to be changed, although subtly, between the silicon nitride films of the semiconductor wafers formed directly after the component protective coating 2 is formed and the silicon nitride films of the semiconductor wafers formed directly after the silicon nitride films 3 (3b) are formed on the surface of the component. If the film quality is changed subtly, there is a possibility for a deviation of uniformity of the film quality of the silicon nitride films 3 to be increased between the semiconductor wafers, as the film forming processing proceeds.

In this respect, in this fourth embodiment, a pre-coating processing is performed to the component as shown in operation S5 after the component protecting processing shown in operations S1 and S1a is performed, and then the silicon film 2 having the rough surface on the component is covered with a coating having the same material as the thin film to be formed, i.e. the silicon nitride coating in this embodiment. Accordingly, the material of the surface of the quartz component arranged in the interior of the processing chamber 101 directly after the component protective coating is formed can be equal to that directly after the film forming processing is performed.

Therefore, according to the fourth embodiment, it is possible to obtain the same advantage as the first to third embodiments and simultaneously to obtain an advantage of further suppressing an increase in deviation of uniformity of the film quality of the thin films, e.g., the silicon nitride films on the semiconductor wafers in this embodiment, between the wafers.

Although the present disclosure has been described with reference to the several embodiments, the present disclosure is not limited to the embodiments but can be variously modified within the scope without departing from the spirit of the present disclosure.

For example, although a batch type film forming apparatus has been illustrated in the aforementioned embodiments, the film forming apparatus is not limited to the batch type and may be a single type film forming apparatus.

Furthermore, the aforementioned embodiments have been described with the film forming apparatus 100 as an example in which the cylindrical processing chamber 101 having an open lower end and a ceiling defines a processing space allowing the film forming processing to be performed in a lump on a plurality of semiconductor wafers W. However, the film forming apparatus is not limited thereto. For example, a film forming apparatus, which includes a cylindrical quartz outer wall having a ceiling and a cylindrical quartz inner wall installed inside of the outer wall, wherein the inside space of the inner wall is defined as a processing space for performing the film forming processing on a plurality of semiconductor wafers W in a lump and a space between the outer wall and the inner wall is defined as an evacuation path, may also be applied to the aforementioned embodiments.

Furthermore, although the film forming apparatus 100 has the plasma generation unit 124 in the aforementioned embodiments, it is natural that the plasma generation unit 124 may be omitted. In such a case, the film forming apparatus 100 is a thermal CVD film forming apparatus or a thermal ALD film forming apparatus.

Moreover, although small, silicon nitride may be deposited even on an inner side of the nitriding agent-containing gas dispersion nozzle 120a and an inner side of the inert gas inlet nozzle 120d, or inner peripheral surfaces of the gas injection holes 121 a of the nitriding agent-containing gas dispersion nozzle 120a and an inner peripheral surface of a gas ejection portion of the inert gas inlet nozzle 120d. When this small deposition of silicon nitride may adversely affect the nitriding agent-containing gas dispersion nozzle 120a or the inert gas inlet nozzle 120d, a silicon source gas, for example, a monosilane gas, should be supplied from the silicon source gas supply source 118b even to the nitriding agent-containing gas dispersion nozzle 120a and the inert gas inlet nozzle 120d when the component protective coating, e.g., the silicon film 2 having the rough surface in the aforementioned embodiments, is formed. In such a manner, the adverse influence can be solved by forming the silicon film 2 having the rough surface on the inner side of the nitriding agent-containing gas dispersion nozzle 120a and the inner side of the inert gas inlet nozzle 120d, and the inner peripheral surface of the gas injection holes 121a of the nitriding agent-containing gas dispersion nozzle 120a and the inner peripheral surface of the gas ejection portion of the inert gas inlet nozzle 120d.

According to the present disclosure, it is possible to provide a component protection method of a film forming apparatus capable of suppressing damage of a component of the film forming apparatus even though a thin film is deposited, and a film forming method including the component protection method.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A method of protecting a component of a film forming apparatus, the method comprising:
forming a film having a rough surface on a surface of a component of a film forming apparatus such that the surface of the component is coated with the film having the rough surface, before or after film forming processing on a target substrate in the interior of a processing chamber of a film forming apparatus,
wherein the component is located in the interior of the processing chamber and exposed to a film forming atmosphere during the film forming processing on the target substrate.

2. The method of claim 1, wherein the component is made of quartz.

3. The method of claim 2, wherein the component includes at least any one of the processing chamber, and a gas inlet tube configured to introduce gas, a substrate loading jig configured to load the target substrate, and a thermal insulation container arranged in the processing chamber.

4. The method of claim 1, wherein the film having the rough surface is a silicon film having a rough surface.

5. The method of claim 4, wherein the silicon film having the rough surface is formed, after the silicon film is formed on the surface of the component, by decreasing pressure around the silicon film and agglomerating silicon on a surface portion of the silicon film.

6. The method of claim 5, wherein the silicon film includes an amorphous silicon film.

7. The method of claims 4, wherein the film to be formed by the film forming processing is a silicon nitride film.

8. A film forming method of performing film forming processing on a target substrate, the method comprising:
carrying a target substrate into an interior of a processing chamber of a film forming apparatus, the target substrate being loaded in a substrate loading jig;
performing film forming processing on the target substrate in the interior of the processing chamber; and
forming a film having a rough surface on a surface of a component of the film forming apparatus such that the surface of the component is coated with the film having the rough surface, before the film forming processing on the target substrate, or after the film forming processing on the target substrate, or both before and after the film forming processing on the target substrate,
wherein the component is located in the interior of the processing chamber and exposed to a film forming atmosphere during the film forming processing on the target substrate.

9. The method of claim 8, wherein when forming the film having the rough surface is performed after the film forming processing, or both before and after the film forming processing, forming the film having the rough surface is performed whenever the film forming processing is performed one time or a plurality of times.

10. The method of claim 8, further comprising coating the film having the rough surface with a film identical to the film to be formed after forming the film having the rough surface.

11. The method of claim 8, wherein the component is made of quartz.

12. The method of claim 11, wherein the component includes it least any one of the processing chamber, and a gas inlet tube configured to introduce gas, a substrate loading jig configured to load a target substrate to be processed, and a thermal insulation container arranged in the processing chamber.

13. The method of claim 8, wherein the film having the rough surface is a silicon film having a rough surface.

14. The method of claim 13, wherein the silicon film having the rough surface is formed, after the silicon film is formed on the surface of the component, by decreasing pressure around the silicon film and agglomerating silicon on a surface portion of the silicon film.

15. The method of claim 14, wherein the silicon film includes an amorphous silicon film.

16. The method of claim 13, wherein the film to be formed by the film forming processing is a silicon nitride film.
